(19) United States
(12) Patent Application Publication
(10) Pub. No.: US 2007/0104053 A1
(43) Pub. Date: May 10, 2007

(54) METHOD FOR CONTROLLING AN OPTICAL DISC DRIVE TO RESUME INTERRUPTED RECORDING ON AN OPTICAL DISC, CIRCUIT THEREOF, AND OPTICAL DISC DRIVE CAPABLE OF RESUMING INTERRUPTED RECORDING ON AN OPTICAL DISC

(76) Inventors: Hsin-Cheng Chen, Tainan Hsien (TW); Ching-Wen Hsueh, I-Lan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/163,940

(22) Filed: Nov. 4, 2005

(51) Int. Cl. G11B 20/10

(52) U.S. Cl. 369/47.11

(57) ABSTRACT

A method for controlling an optical disc drive to resume interrupted recording on an optical disc includes: when the recording of a first recording unit block (RUB) is interrupted, storing an address thereof and storing a first value corresponding to the number of recorded sets of data of the first RUB; according to the address, searching a pseudo-recording start position corresponding to a recorded set of data of a specific RUB which is the first RUB or a second RUB recorded on the optical disc prior to the first RUB; re-encoding at least a portion of raw data corresponding to recorded sets of data on the optical disc and performing pseudo-recording from the pseudo-recording start position without physically writing on the optical disc until a second value matches a target value; and physically writing on the optical disc when the second value matches the target value to resume recording.

### BACKGROUND

The present invention relates to optical disc drives, and more particularly, to methods for controlling an optical disc drive to resume interrupted recording on an optical disc, circuits thereof, and optical disc drives capable of resuming interrupted recording on an optical disc.

According to the related art, resuming interrupted recording on an optical disc, for example, a Digital Versatile Disc (DVD) such as a DVD-Recordable (DVD-R) or a DVD-Rewritable (DVD-RW), is typically implemented by sync detection of a reproduced signal such as a Radio Frequency (RF) signal which represents data read from the optical disc. According to the sync detection, the number of syncs, for example, the number of frame syncs or the number of sub code syncs, can be counted to generate at least one counter value. When the counter value mentioned above matches a corresponding counter value generated during a writing procedure previously interrupted, i.e., the interrupted location is detected, the interrupted recording can be resumed. Please refer to U.S. Pat. No. 6,198,707 and U.S. Pat. No. 6,252,838 for related information.

### SUMMARY

It is an objective of the claimed invention to provide methods for controlling an optical disc drive to resume interrupted recording on an optical disc, circuits thereof, and optical disc drives capable of resuming interrupted recording on an optical disc.

An exemplary embodiment of a method for controlling an optical disc drive to resume interrupted recording on an optical disc comprises: when the recording of a first recording unit block (RUB) is interrupted, storing an address of the first RUB and storing a first value corresponding to the number of recorded sets of data of the first RUB; according to the address of the first RUB, searching a pseudo-recording start position corresponding to a recorded set of data of a specific RUB which is either the first RUB or a second RUB that is recorded on the optical disc prior to the first RUB; re-encoding at least a portion of raw data corresponding to recorded sets of data on the optical disc and performing pseudo-recording from the pseudo-recording start position without physically writing on the optical disc until a second value corresponding to the pseudo-recording start position and a current pseudo-recording position matches a target value corresponding to the first value and the pseudo-recording start position; and physically writing on the optical disc when the second value matches the target value to resume recording the first RUB.

An exemplary embodiment of a circuit for controlling an optical disc drive to resume interrupted recording on an optical disc comprises: a processor for performing recording control of the optical disc drive, when the recording of a first RUB is interrupted, the processor storing an address of the first RUB and storing a first value corresponding to the number of recorded sets of data of the first RUB, wherein according to the address of the first RUB, the processor controls an optical pickup of the optical disc drive to search a pseudo-recording start position corresponding to a recorded set of data of a specific RUB which is either the first RUB or a second RUB that is recorded on the optical disc prior to the first RUB; a data encoder coupled to the processor for re-encoding at least a portion of raw data corresponding to recorded sets of data on the optical disc and performing pseudo-recording from the pseudo-recording start position until a second value corresponding to the pseudo-recording start position and a current pseudo-recording position matches a target value corresponding to the first value and the pseudo-recording start position; and a laser control circuit coupled to the data encoder for driving the laser of the optical pickup; wherein the laser control circuit controls the optical pickup to prevent physically writing on the optical disc until the second value matches the target value, and controls the optical pickup to physically write on the optical disc when the second value matches the target value to resume recording the first RUB.

An exemplary embodiment of an optical disc drive capable of resuming interrupted recording on an optical disc comprises: an optical pickup for accessing the optical disc; a processor for performing recording control of the optical disc drive, when the recording of a first RUB is interrupted, the processor storing an address of the first RUB and storing a first value corresponding to the number of recorded sets of data of the first RUB, wherein according to the address of the first RUB, the processor controls the optical pickup to search a pseudo-recording start position corresponding to a recorded set of data of a specific RUB which is either the first RUB or a second RUB that is recorded on the optical disc prior to the first RUB; a data encoder coupled to the processor for re-encoding at least a portion of raw data corresponding to recorded sets of data on the optical disc and performing pseudo-recording from the pseudo-recording start position until a second value corresponding to the pseudo-recording start position and a current pseudo-recording position matches a target value corresponding to the first value and the pseudo-recording start position; and a laser control circuit coupled to the data encoder for driving the laser of the optical pickup; wherein the laser control circuit controls the optical pickup to prevent physically writing on the optical disc until the second value matches the target value, and controls the optical pickup to physically write on the optical disc when the second value matches the target value to resume recording the first RUB.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an optical disc drive capable of resuming interrupted recording on an optical disc according to one embodiment of the present invention.

FIG. 2 is a flowchart of a method for controlling an optical disc drive to resume interrupted recording on an optical disc according to one embodiment of the present invention.

FIG. 3 illustrates details of Step 916 shown in FIG. 2.

FIG. 4 is a diagram of an optical disc drive capable of resuming interrupted recording on an optical disc according to one embodiment of the present invention.

FIG. 5 is a diagram of an optical disc drive capable of resuming interrupted recording on an optical disc according to one embodiment of the present invention.

FIG. 6 is a diagram of an optical disc drive capable of resuming interrupted recording on an optical disc according to one embodiment of the present invention.

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

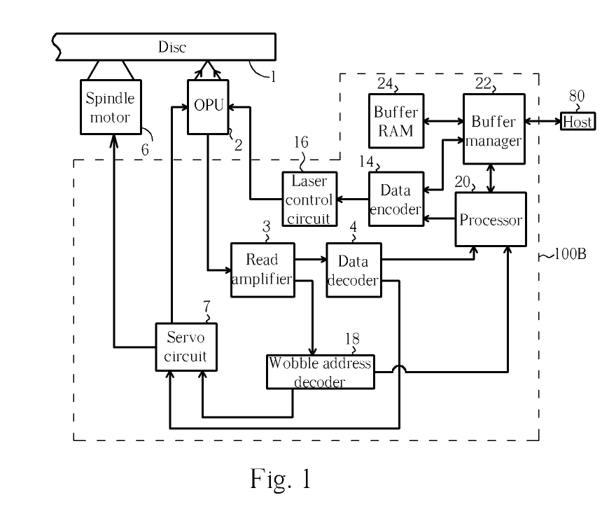

Please refer to FIG. 1. FIG. 1 is a diagram of an optical disc drive capable of resuming interrupted recording on an optical disc 1 according to one embodiment of the present invention, where the optical disc drive comprises a loader comprising an optical pickup (OPU) 2 and a spindle motor 6, and a circuit 100B, which is positioned in the optical disc drive and utilized for controlling the optical disc drive to resume interrupted recording on the optical disc 1. According to the present invention, the optical disc can be a Compact Disc (CD), a Digital Versatile Disc (DVD), a High Density DVD (HD-DVD), or a Blu-ray disc (BD), and the optical disc drive can be a corresponding disc drive capable of accessing the optical disc, e.g., a CD drive, a DVD drive, a HD-DVD drive, or a BD drive. In this embodiment, the optical disc 1 is a DVD such as a DVD-Recordable (DVD-R) or a DVD-Rewritable (DVD-RW), and the optical disc drive is a DVD drive accordingly. As shown in FIG. 1, the circuit 100B comprises a read amplifier 3, a data decoder 4, a servo circuit 7, a data encoder 14, a laser control circuit 16, a wobble address decoder 18, a processor 20, a buffer manager 22, and a buffer RAM 24, where the buffer manager 22 is coupled to a host 80 such as a personal computer (PC). Please note that the architecture of the processor 20 can be replaced with a plurality of processors for performing the same functionalities according to another embodiment of the present invention.

In a read procedure of the optical disc drive, a read channel is involved, where the read channel typically comprises the read amplifier 3 and the data decoder 4. The read amplifier 3 is capable of amplifying a reproduced signal outputted from the OPU 2 to correspondingly generate an amplified signal, where the reproduced signal represents data read from the optical disc 1. The data decoder 4 is capable of decoding the data according to the amplified signal, and deriving logical addresses such as sector IDs. The servo circuit 7 performs servo control for the OPU 2 and the spindle motor 6. The wobble address decoder 18 is utilized for deriving physical addresses such as ADIP addresses.

In a writing procedure of the optical drive, a writing channel is involved, where the writing channel typically comprises the data encoder 14 and the laser control circuit 16. Data to be recorded on the optical disc 1 is transferred from the host 80 through the buffer manager 22 to the buffer RAM 24 and temporarily stored in the buffer RAM 24. In addition, the buffer manager 22 is capable of transferring the data stored in the buffer RAM 24 to the data encoder 14 if needed. The data encoder 14 encodes the data stored in the buffer RAM 24 to generate encoded data. According to the encoded data, the laser control circuit 16 may control the writing power of the laser emitted from the OPU 2 or control the OPU 2 to emit laser or not, in order to record the encoded data on the optical disc 1.

During the writing procedure, if the speed that the buffer RAM 24 buffers the data from the host 80 is lower than the encoding speed of the data encoder 14, that means the data transfer rate (which is also referred to as the data rate) between the host 80 and the buffer RAM 24 is less than the data transfer rate between the buffer RAM 24 and the data encoder 14. In order to prevent the data in the buffer RAM 24 from being used up by the data encoder 14, when an amount of the data in the buffer RAM 24 is less than a first predetermined value, the buffer manager 22 notifies the processor 20 that buffer under-run would occur. As a result, the processor 20 interrupts the writing procedure to prevent from a failure of the writing procedure. Additionally, when the amount of the data in the buffer RAM 24 becomes greater and reaches a second predetermined value (which is typically greater than the first predetermined value), the buffer manager 22 notifies the processor 20 that the data amount is enough for safely resuming the writing procedure. As a result, the processor 20 resumes the writing procedure.

Similarly, when another interruptive event such as external mechanical shock is detected, the processor 20 also interrupts the writing procedure to prevent from a failure of the writing procedure. When the interruptive event is removed, the processor 20 resumes the writing procedure.

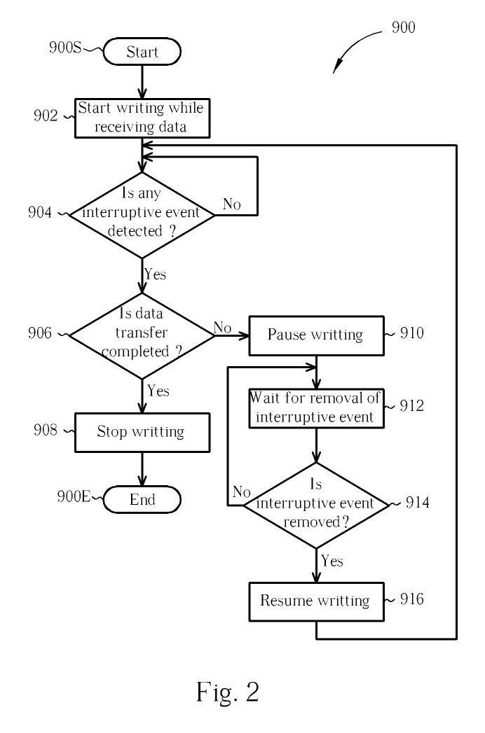

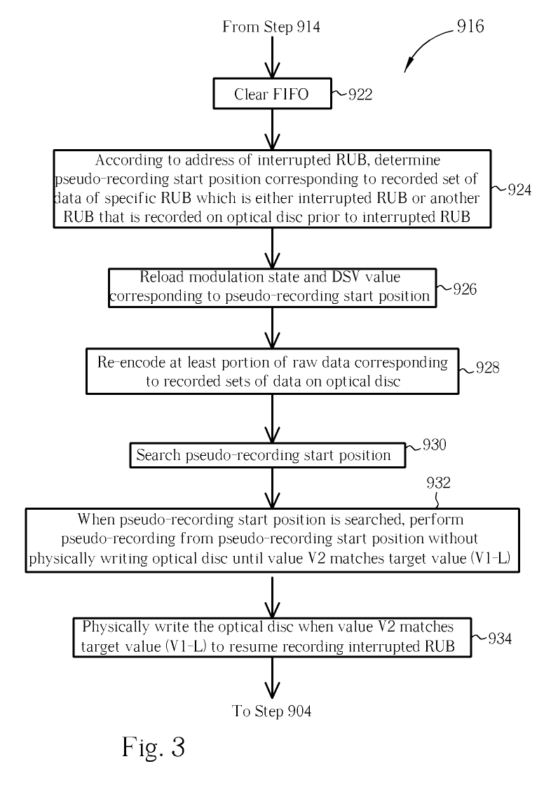

FIG. 2 is a flowchart of a method 900 for controlling an optical disc drive to resume interrupted recording on an optical disc according to one embodiment of the present invention, where FIG. 3 illustrates details of Step 916 shown in FIG. 2. The method 900 can be applied to the architecture shown in FIG. 1, and described as follows. According to this embodiment, the processor 20 performs not only the writing control comprising the recording control but also the read control of the optical disc drive mentioned above. The processor 20 controls the optical disc drive to execute Step 902, i.e., start writing while receiving data from the host 80, and execute Step 904 to check if any interruptive event such as buffer under-run or external mechanical shock is detected. In a normal condition, which is not completely shown in FIG. 2 for simplicity, the writing procedure is stopped if data transfer is completed. In an abnormal condition as shown in FIG. 2, if any interruptive event mentioned above is detected, Step 906 is entered, so the processor 20 controls the optical disc drive to check if data transfer is completed. Here, if data transfer is completed, Step 908 is entered, so the processor 20 controls the optical disc drive to stop writing. On the other hand, if data transfer is not completed, Step 910 is entered, so the processor 20 controls the optical disc drive to execute the working flow comprising Steps 910, 912, 914, and 916, and then reenter Step 904.

If the recording of a recording unit block (RUB) such as a sector or an Error Correction Code (ECC) block is interrupted, the RUB is also referred to as an interrupted RUB. It is important to store information related to the location where the RUB is interrupted, in order to resume writing in Step 916. According to this embodiment, while controlling the optical disc drive to pause writing in Step 910, the processor 20 stores an address of the interrupted RUB and may further store a value V1 and output a target value (V1−L), where either the value V1 or the target value (V1−L) is corresponding to the number of recorded sets of data of the interrupted RUB. The value L (which is zero for an ideal case without any signal delay) is a constant representing a hardware latency. According to the present invention, the address can be a physical address such as an ADIP address of the interrupted RUB, or a logical address such as a sector ID of the interrupted RUB. Additionally, the address stored by the processor 20 typically corresponds to the beginning of the interrupted RUB.

According to a loop comprising Step 912 and Step 914 shown in FIG. 2, the processor 20 controls the optical disc drive to wait for removal of the interruptive event. If the removal of the interruptive event is detected in Step 914, enter Step 916; otherwise, reenter Step 912.

In the present invention, we may call the interrupted RUB mentioned above the interrupted RUB Ri. According to the address of the interrupted RUB Ri, the processor 20 typically controls the OPU 2 to search a pseudo-recording start position corresponding to a recorded set of data of a specific RUB Rs which is either the interrupted RUB Ri or a RUB Rp that is recorded on the optical disc 1 prior to the interrupted RUB Ri. In this embodiment, to search out the pseudo-recording start position, the pseudo-recording start position is first determined according to the address of the interrupted RUB Ri and searching the pseudo-recording start position is performed later.

In Step 922, as shown in FIG. 3, the data encoder 14 firstly clears a First In First Out (FIFO) memory therein, in order to perform re-encoding from a recorded set of data corresponding to a head position of a RUB that had been recorded onto the optical disc 1. The outset of the re-encoding process may correspond to a head position of a recorded RUB, e.g., the specific RUB Rs, which could be either the interrupted RUB Ri or the RUB Rp that had been recorded prior to the interrupted RUB Ri.

In Step 924, according to the address of the interrupted RUB Ri, the processor 20 determines the pseudo-recording start position corresponding to the recorded set of data of the specific RUB Rs (which is either the interrupted RUB Ri or the RUB Rp that is recorded on the optical disc 1 prior to the interrupted RUB Ri).

In Step 926, the data encoder 14 reloads information related to the pseudo-recording start position, for example, the modulation state(s), and a DSV value corresponding to the pseudo-recording start position. Some other information such as a certain value of the rotational speed can be reloaded in this step, in order to perform pseudo-recording utilizing the same rotational speed of the optical disc 1 as that utilized before the recording of the interrupted RUB Ri was interrupted.

In Step 928, the data encoder 14 re-encodes at least a portion of raw data corresponding to recorded sets of data on the optical disc 1.

In Step 930, the processor 20 controls the OPU 2 to search the pseudo-recording start position. Once the pseudo-recording start position is found, the optical disc drive may perform pseudo-recording from the pseudo-recording start position, where the pseudo-recording start position typically corresponds to the beginning of the specific RUB Rs, i.e., the beginning of the interrupted RUB Ri or the beginning of the RUB Rp. Please note that performing pseudo-recording means performing recording operations without physically writing on the optical disc. For example, the power of the laser can be temporarily turned off, disabled, or blocked, so although the recording operations is performed, no data is actually written on the optical disc and no data on the optical disc is altered during pseudo-recording.

In Step 932, when the pseudo-recording start position is searched, the data encoder 14 performs pseudo-recording from the pseudo-recording start position without physically writing on the optical disc 1 until a value V2 matches the target value (V1−L), where the value V2 corresponds to the pseudo-recording start position and a current pseudo-recording position (e.g., a real position of the OPU 2), and more specifically, corresponds to the number of pseudo-recorded sets of data or the number of re-encoded sets of data. Additionally, the value L can be considered zero if the hardware latency is negligible. It is noted that the value L corresponds to a difference between an ideal location of the pseudo-recording start position and a real location of the OPU 2 when the data decoder 4 or the wobble address decoder 18 detects out the pseudo-recording start position. If the hardware latency is negligible, the target value (V1−L) can be replaced with the value V1 in related descriptions hereafter. The laser control circuit 16 can be utilized for driving the laser of the OPU 2. Here, in this step, the laser control circuit 16 controls the OPU 2 to prevent physically writing on the optical disc until the value V2 matches the target value (V1−L).

In Step 934, the laser control circuit 16 controls the OPU 2 to physically write on the optical disc 1 when the value V2 matches the target value (V1−L) to resume recording the interrupted RUB Ri.

It is noted that the value V1 can be the number of recorded sets of data of the interrupted RUB, and the value V2 can be the number of pseudo-recorded sets of data or the number of re-encoded sets of data, where the number of pseudo-recorded sets of data is typically equal to the number of re-encoded sets of data. In this situation, the criterion that the value V2 matches the target value (V1−L) means the number of pseudo-recorded sets of data or the number of re-encoded sets of data matches the number of recorded sets of data of the interrupted RUB Ri. Here, if the specific RUB Rs is the interrupted RUB Ri, checking whether the value V2 matches the target value (V1−L) typically means checking whether the value V2 is equal to the target value (V1−L). On the other hand, if the specific RUB Rs is the RUB Rp, checking whether the value V2 matches the target value (V1−L) typically means checking whether the value V2 is equal to another target value being the target value (V1−L) plus an offset value representing the offset between the RUB Ri and the RUB Rp. In detail, if the number of sets of data in one RUB is equal to M, and if the offset between the RUB Ri and the RUB Rp is equal to N RUB(s), where N is a positive integer, then the offset value is equal to (M*N), and therefore, checking whether the value V2 matches the target value (V1−L) typically means checking whether the value V2 is equal to the target value (V1+M*N−L).

According to the present invention, different kinds of RUBs can be involved, where each set of data within one RUB represents a sub-unit within the RUB. If the optical disc is a CD, each of the RUBs can be defined as a sector. In addition, if the optical disc is a DVD or a HD-DVD, each of the RUBs can be defined as a sector or an ECC block. Additionally, if the optical disc is a BD, each of the RUBs can be defined as a sector or a cluster.

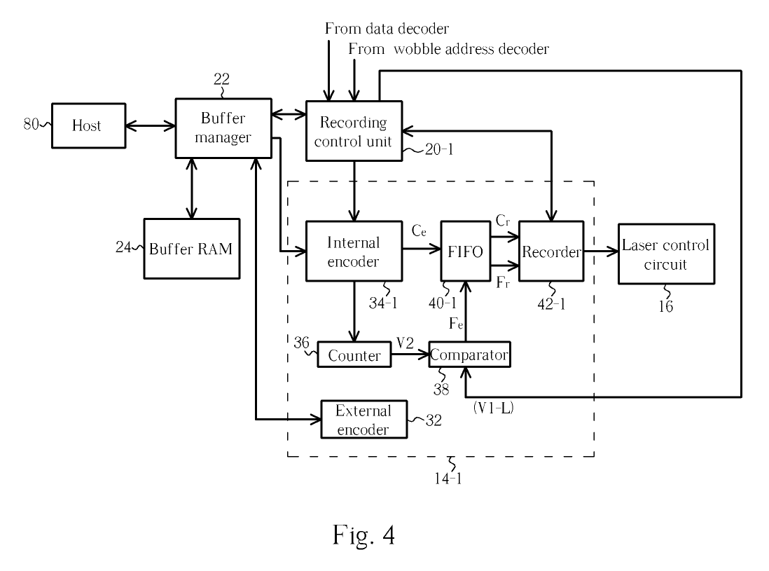

FIG. 4 is a diagram of an optical disc drive capable of resuming interrupted recording on an optical disc according to one embodiment of the present invention, where the data encoder 14 shown in FIG. 1 is replaced with another data encoder 14-1, and the processor 20 shown in FIG. 1 is replaced with another processor, the recording control unit 20-1. The recording control unit 20-1 controls the data encoder 14-1 to perform data encoding via the buffer manager 22. The external encoder 32 reads data from the buffer RAM 24 under the control of the buffer manager 22 and additionally provides an ID error detection (IED) code and an error detection code (EDC), conducts a scramble operation, and provides an outer code ECC, and then writes the result on the buffer RAM 24. The internal encoder 34-1 reads the data from the buffer RAM 24 under the control of the buffer manager 22 and additionally provides the inner error correction code, conducts an interleave operation, and further conducts the eight-to-sixteen modulation for the data to output. According to the present invention, the counter 36 can be positioned inside or outside the internal encoder 34-1. In this embodiment, the counter 36 can be utilized for counting the value V2 corresponding to the number of re-encoded sets of data. In particular, in this embodiment, the specific RUB Rs is the interrupted RUB Ri, the value V1 is the number of recorded sets of data of the interrupted RUB Ri, and the value V2 is the number of re-encoded sets of data.

Accordingly, the comparator 38 compares the value V2 outputted from the counter 36 and the target value (V1−L) outputted from the recording control unit 20-1. The FIFO memory 40-1 shown in FIG. 4 is utilized for buffering encoded data Cₑ outputted from the internal encoder 34-1 together with the corresponding comparison result Fₑ outputted from the comparator 38. As shown in FIG. 4, the encoded data Cₑ and the comparison result Fₑ are temporarily stored in the FIFO memory 40-1 and outputted to be the encoded data Cᵣ and the comparison result Fᵣ, respectively. A recorder 42-1 is utilized for retrieving encoded data Cᵣ from the FIFO memory 40-1 and converting the encoded data Cᵣ into the non-return-to-zero-inverted (NRZI) format for recording. The recorder 42-1 is also utilized for performing pseudo-recording according to the comparison result Fᵣ, i.e., the comparison result Fₑ retrieved from the FIFO memory 40-1. In this embodiment, the comparison result Fᵣ may indicate whether the value V2 is equal to the target value (V1−L), so the recorder 42-1 will be notified if the value V2 is equal to the target value (V1−L). Therefore, the laser control circuit 16 may control the OPU 2 whether to physically write on the optical disc 1 according to the comparison result Fᵣ, i.e., the comparison result Fₑ retrieved from the FIFO memory 40-1.

It is noted that in a normal condition of the writing procedure, the recording control unit 20-1 may control the recorder 42-1 through a direct connection as shown in FIG. 4, where the direct connection (which can be a single wire or a plurality of wires) is also utilized during the transition from the normal condition to an abnormal condition such as that shown in FIG. 2. For example, while controlling the recorder 42-1 to pause writing in Step 910, the recording control unit 20-1 stores the address of the interrupted RUB Ri and stores the value V1 corresponding to the number of recorded sets of data of the interrupted RUB Ri, where the recording control unit 20-1 may simply store the target value (V1−L) rather than the value V1. Additionally, in the normal condition, flags such as the comparison result Fᵣ or the comparison result Fₑ shown in FIG. 4 are not needed, so after Step 916, the counter 36 and the comparator 38 can be disabled.

In a variation of the embodiment shown in FIG. 4, while controlling the recorder 42-1 to pause writing in Step 910, the recording control unit 20-1 stores the address of the interrupted RUB Ri and stores a plurality of values corresponding to the number of recorded sets of data of the interrupted RUB Ri. For example, if the optical disc is a DVD and each of the RUBs is defined as an ECC block, the recording control unit 20-1 may store the number of recorded sectors, the number of recorded codewords (sync frames) on the optical disc posterior to the recorded sectors mentioned above, and the number of recorded bytes on the optical disc posterior to the recorded codewords (sync frames) mentioned above. In another variation similar to the variation mentioned above, if the optical disc is a DVD and each of the RUBs is defined as a sector, the recording control unit 20-1 may store the number of recorded codewords (sync frames), and the number of recorded bytes on the optical disc posterior to the recorded codewords (sync frames) mentioned above.

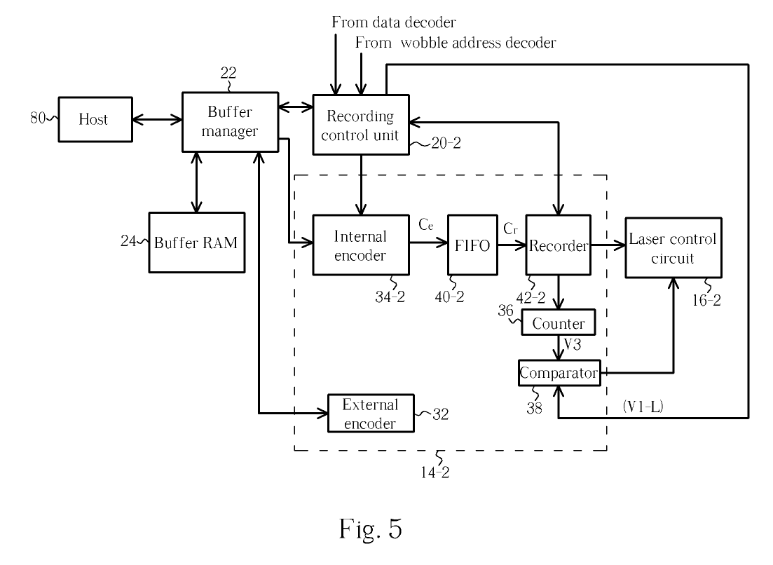

FIG. 5 is a diagram of an optical disc drive capable of resuming interrupted recording on an optical disc according to one embodiment of the present invention, where the data encoder 14 shown in FIG. 1 is replaced with another data encoder 14-2, the laser control circuit 16 shown in FIG. 1 is replaced with another laser control circuit 16-2, and the processor 20 shown in FIG. 1 is replaced with another processor, the recording control unit 20-2. In order to prevent confusion between what the counter 36 counts in the embodiment shown in FIG. 4 and what the counter 36 counts in the embodiment shown in FIG. 5, the value V2 outputted from the counter 36 is replaced with a value V3. The internal encoder 34-2 performs internal encoding of the RUBs according to control of the recording control unit 20-2. Similar to the embodiment shown in FIG. 4, the FIFO memory 40-2 is utilized for buffering the encoded data Cₑ outputted from the internal encoder 34-2, where the encoded data Cₑ is temporarily stored in the FIFO memory 40-2 and outputted to be the encoded data Cᵣ. The recorder 42-2 is utilized for performing pseudo-recording. According to the present invention, the counter 36 can be positioned inside or outside the recorder 42-2. In this embodiment, the counter 36 can be utilized for counting the value V3 corresponding to the number of pseudo-recorded sets of data. In particular, in this embodiment, the specific RUB Rs is the interrupted RUB Ri, the value V1 is the number of recorded sets of data of the interrupted RUB Ri, and the value V3 is the number of pseudo-recorded sets of data.

Accordingly, the comparator 38 compares the value V3 outputted from the counter 36 and the target value (V1−L) outputted from the recording control unit 20-2 to output a comparison result to the laser control circuit 16-2. In this embodiment, the comparison result outputted from the comparator 38 may indicate whether the value V3 is equal to the target value (V1−L), so the laser control circuit 16-2 will be notified if the value V3 is equal to the target value (V1−L). Therefore, the laser control circuit 16-2 may control the OPU 2 whether to physically write on the optical disc 1 according to the comparison result outputted from the comparator 38.

It is noted that in a normal condition of the writing procedure, the recording control unit 20-2 may control the recorder 42-2 through a direct connection as shown in FIG. 5, where the direct connection is also utilized during the transition from the normal condition to an abnormal condition such as that shown in FIG. 2. For example, while controlling the recorder 42-2 to pause writing in Step 910, the recording control unit 20-2 stores the address of the interrupted RUB Ri and stores the value V1 corresponding to the number of recorded sets of data of the interrupted RUB Ri, where the recording control unit 20-2 may simply store the target value (V1−L) rather than the value V1. Additionally, in the normal condition, the comparison result mentioned above is not needed, so after Step 916, the counter 36 and the comparator 38 can be disabled.

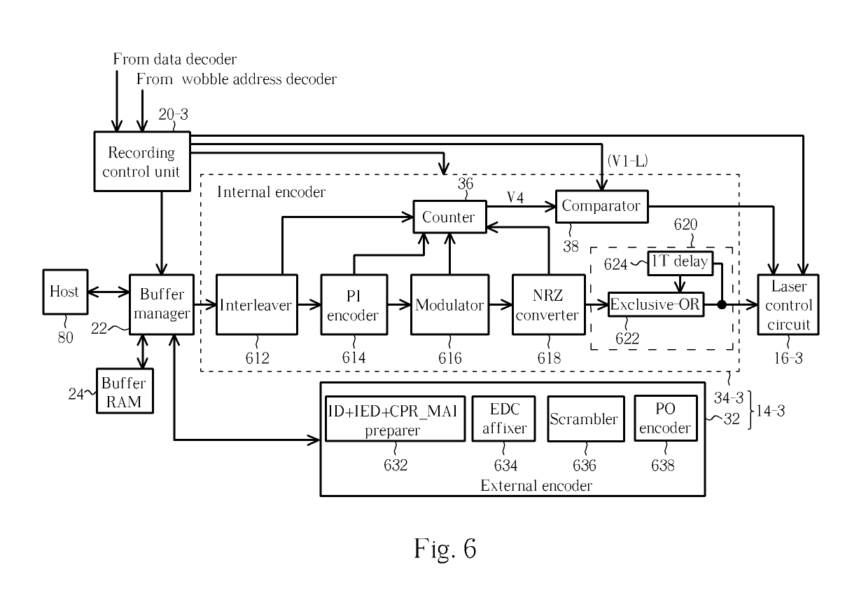

FIG. 6 illustrates another embodiment of the present invention, where the data encoder 14 shown in FIG. 1 is replaced with another data encoder 14-3, the laser control circuit 16 shown in FIG. 1 is replaced with another laser control circuit 16-3, and the processor 20 shown in FIG. 1 is replaced with another processor, the recording control unit 20-3. The Operations of the buffer manager 22, the buffer RAM 24, the recording control unit 20-3, and the laser control circuit 16-3 are similar to those in the embodiments shown in FIG. 4 and FIG. 5, and are therefore not repeated in detail here. Within the data encoder 14-3, the external encoder 32 comprises an ID+IED+CPR_MAI preparer 632, an EDC affixer 634,a scrambler 636, and a PO encoder 638, and the internal encoder 34-3 comprises an interleaver 612, a PI encoder 614, a modulator 616, an NRZ converter 618, and an NRZI converter 620 comprising an exclusive-OR logic 622 and a 1-T delay unit 624, where the delay introduced by the 1-T delay unit 624 is equal to one channel clock period.

The ID+IED+CPR_MAI preparer 632 prepares a 4-byte ID, calculates a 2-byte IED code, and further prepares a user-defined number in a 6-byte CPR_MAI field (which can be varied depending on different implementation choices) posterior to the 2-byte IED code. The EDC affixer 634 arranges the information data (which is transferred from the host 80) to be main information data posterior to the CPR_MAI field, where there are 2048 bytes in each data frame of the main information data. In addition, the EDC affixer 634 calculates a 4-byte EDC according to the ID, the IED code, and the CPR_MAI number (i.e., the user-defined number in the 6-byte CPR_MAI field) prepared by the ID+IED+CPR_MAI preparer 632 and according to the main information data mentioned above. Thus, the last data frame comprises 2064 bytes, which are the 4-byte ID, the 2-byte IED, the 6-byte CPR_MAI number, the 2048-byte main information data, and the 4-byte EDC. The 4-byte ID, the 2-byte IED, the 6-byte CPR_MAI number, and the 4-byte EDC are written into the buffer RAM 24 through the buffer manager 22. The scrambler 636 scrambles the 2048-byte main information data in order to randomize the 2048-byte main information data. As a result, 16 continuously transmitted data frames form an ECC block after being scrambled. Additionally, the PO encoder 638 utilize an ECC block as a unit to generate Parity of Outer Code, and write the Parity of Outer Code into the buffer RAM 24 through the buffer manager 22.

While reading the data of each ECC block from the buffer RAM 24 through the buffer manager 22, the interleaver 612 interleaves one of the PO rows at a time after reading every 12 rows of the ECC block. The PI encoder 614 performs PI encoding on the data outputted from the interleaver 612, and outputs PI-encoded data bytes. The modulator 616 performs 8-16 modulation on the PI-encoded data bytes, and adds a 32-bit sync pattern prior to every 91 data bytes generated by the modulator 616. As a result, the NRZ converter 618 and the NRZI converter 620 perform NRZ conversion and NRZI conversion, in order to output 16 channel bits NRZI converted pulses as outputs of the data encoder 14-3.

In order to prevent confusion between what the counter 36 counts in the embodiment shown in FIG. 4 (or FIG. 5) and what the counter 36 counts in the embodiment shown in FIG. 6, the value outputted from the counter 36 is replaced with a value V4 in the embodiment shown in FIG. 6. The internal encoder 34-3 performs internal re-encoding of the RUBs according to control of the recording control unit 20-3. The internal encoder 34-3 is also utilized for performing pseudo-recording. According to the present invention, the counter 36 can be positioned inside or outside the internal encoder 34-3. In this embodiment, the counter 36 can be utilized for counting the value V4 corresponding to the number of re-encoded sets of data of any encoding stage (e.g., the interleaver 612, the PI encoder 614, the modulator 616, or the NRZ converter 618). In particular, in this embodiment, the specific RUB Rs is the interrupted RUB Ri, the value V1 is the number of recorded sets of data of the interrupted RUB Ri, and the value V4 is the number of re-encoded sets of data of any encoding stage.

Accordingly, the comparator 38 compares the value V4 outputted from the counter 36 and the target value (V1−L) outputted from the recording control unit 20-3 to output a comparison result to the laser control circuit 16-3. In this embodiment, the comparison result outputted from the comparator 38 may indicate whether the value V4 is equal to the target value (V1−L), so the laser control circuit 16-3 will be notified if the value V4 is equal to the target value (V1−L). Therefore, the laser control circuit 16-3 may control the OPU 2 whether to physically write on the optical disc 1 according to the comparison result outputted from the comparator 38.

It is noted that in a normal condition of the writing procedure, the recording control unit 20-3 may control the internal encoder 34-3 and the laser control circuit 16-3 through a direct connection as shown in FIG. 6, where the direct connection is also utilized during the transition from the normal condition to an abnormal condition such as that shown in FIG. 2. For example, while controlling the internal encoder 34-3 to pause encoding and recording, and the laser control circuit 16-3 to pause writing in Step 910, the recording control unit 20-3 stores the address of the interrupted RUB Ri and stores the value V1 corresponding to the number of recorded sets of data of the interrupted RUB Ri, where the recording control unit 20-3 may simply store the target value (V1−L) rather than the value V1. Additionally, in the normal condition, the comparison result mentioned above is not needed, so after Step 916, the counter 36 and the comparator 38 can be disabled.

According to the present invention, even if the interrupted location is not precisely located, i.e., there exists a linking gap or a linking overlap at the linking area on the optical disc 1 after Step 916, it will not degrade the performance of the optical disc drive. The linking gap or the linking overlap is typically smaller than one or more sub-units within a RUB, so different error correction algorithms can be utilized for covering the error(s) due to the linking gap or the linking overlap.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling an optical disc drive to resume interrupted recording on an optical disc, comprising:
when the recording of a first recording unit block (RUB) is interrupted, storing an address of the first RUB and storing a first value corresponding to the number of recorded sets of data of the first RUB;
according to the address of the first RUB, searching a pseudo-recording start position corresponding to a recorded set of data of a specific RUB which is either the first RUB or a second RUB that is recorded on the optical disc prior to the first RUB;
re-encoding at least a portion of raw data corresponding to recorded sets of data on the optical disc and performing pseudo-recording from the pseudo-recording start position without physically writing on the optical disc until a second value corresponding to the pseudo-recording start position and a current pseudo-recording position matches a target value corresponding to the first value and the pseudo-recording start position; and
physically writing on the optical disc when the second value matches the target value to resume recording the first RUB.

2. The method of claim 1, wherein the optical disc is a Compact Disc (CD), a Digital Versatile Disc (DVD), a High Density DVD (HD-DVD), or a Blu-ray disc (BD).

3. The method of claim 2, wherein if the optical disc is a CD, each of the RUBs is a sector.

4. The method of claim 2, wherein if the optical disc is a DVD or a HD-DVD, each of the RUBs is a sector or an Error Correction Code (ECC) block.

5. The method of claim 2, wherein if the optical disc is a BD, each of the RUBs is a sector or a cluster.

6. The method of claim 1, wherein the pseudo-recording start position corresponds to the beginning of the specific RUB.

7. A circuit for controlling an optical disc drive to resume interrupted recording on an optical disc, comprising:
a processor for performing recording control of the optical disc drive, when the recording of a first recording unit block (RUB) is interrupted, the processor storing an address of the first RUB and storing a first value corresponding to the number of recorded sets of data of the first RUB, wherein according to the address of the first RUB, the processor controls an optical pickup of the optical disc drive to search a pseudo-recording start position corresponding to a recorded set of data of a specific RUB which is either the first RUB or a second RUB that is recorded on the optical disc prior to the first RUB;
a data encoder coupled to the processor for re-encoding at least a portion of raw data corresponding to recorded sets of data on the optical disc and performing pseudo-recording from the pseudo-recording start position until a second value corresponding to the pseudo-recording start position and a current pseudo-recording position matches a target value corresponding to the first value and the pseudo-recording start position; and
a laser control circuit coupled to the data encoder for driving the laser of the optical pickup;
wherein the laser control circuit controls the optical pickup to prevent physically writing on the optical disc until the second value matches the target value, and controls the optical pickup to physically write on the optical disc when the second value matches the target value to resume recording the first RUB.

8. The circuit of claim 7, wherein the optical disc is a Compact Disc (CD), a Digital Versatile Disc (DVD), a High Density DVD (HD-DVD), or a Blu-ray disc (BD).

9. The circuit of claim 8, wherein if the optical disc is a CD, each of the RUBs is a sector.

10. The circuit of claim 8, wherein if the optical disc is a DVD or a HD-DVD, each of the RUBs is a sector or an Error Correction Code (ECC) block.

11. The circuit of claim 8, wherein if the optical disc is a BD, each of the RUBs is a sector or a cluster.

12. The circuit of claim 7, wherein the pseudo-recording start position corresponds to the beginning of the specific RUB.

13. The circuit of claim 7, wherein the data encoder further comprises:
an internal encoder coupled to the processor for performing internal encoding of the RUBs according to control of the processor;
a counter positioned inside or outside the internal encoder for counting the second value;
a comparator coupled to the counter and the processor for comparing the second value outputted from the counter and the target value outputted from the processor;
a First In First Out (FIFO) memory coupled to the internal encoder and the comparator for buffering encoded data outputted from the internal encoder together with the corresponding comparison result outputted from the comparator; and
a recorder coupled to the FIFO memory for performing pseudo-recording according to the comparison result;
wherein the laser control circuit is coupled to the recorder, and the laser control circuit controls the optical pickup whether to physically write on the optical disc according to the comparison result.

14. The circuit of claim 7, wherein the data encoder further comprises:
an internal encoder coupled to the processor for performing internal encoding of the RUBs according to control of the processor;
a First In First Out (FIFO) memory coupled to the internal encoder for buffering encoded data outputted from the internal encoder;
a recorder coupled to the FIFO memory for performing pseudo-recording;
a counter positioned inside or outside the recorder for counting the second value; and
a comparator coupled to the counter and the processor for comparing the second value outputted from the counter and the target value outputted from the processor to output a comparison result;
wherein the laser control circuit is coupled to the recorder and the comparator, and the laser control circuit controls the optical pickup whether to physically write on the optical disc according to the comparison result outputted from the comparator.

15. An optical disc drive capable of resuming interrupted recording on an optical disc, comprising:
an optical pickup for accessing the optical disc;
a processor for performing recording control of the optical disc drive, when the recording of a first recording unit block (RUB) is interrupted, the processor storing an address of the first RUB and storing a first value corresponding to the number of recorded sets of data of the first RUB, wherein according to the address of the first RUB, the processor controls the optical pickup to search a pseudo-recording start position corresponding to a recorded set of data of a specific RUB which is either the first RUB or a second RUB that is recorded on the optical disc prior to the first RUB;
a data encoder coupled to the processor for re-encoding at least a portion of raw data corresponding to recorded sets of data on the optical disc and performing pseudo-recording from the pseudo-recording start position until a second value corresponding to the pseudo-recording start position and a current pseudo-recording position matches a target value corresponding to the first value and the pseudo-recording start position; and
a laser control circuit coupled to the data encoder for driving the laser of the optical pickup;
wherein the laser control circuit controls the optical pickup to prevent physically writing on the optical disc until the second value matches the target value, and controls the optical pickup to physically write on the optical disc when the second value matches the target value to resume recording the first RUB.

16. The optical disc drive of claim 15, wherein the optical disc is a Compact Disc (CD), a Digital Versatile Disc (DVD), a High Density DVD (HD-DVD), or a Blu-ray disc (BD).

17. The optical disc drive of claim 15, wherein the pseudo-recording start position corresponds to the beginning of the specific RUB.

18. The optical disc drive of claim 15, wherein the data encoder further comprises:
an internal encoder coupled to the processor for performing internal encoding of the RUBs according to control of the processor;
a counter positioned inside or outside the internal encoder for counting the second value;
a comparator coupled to the counter and the processor for comparing the second value outputted from the counter and the target value outputted from the processor;
a First In First Out (FIFO) memory coupled to the internal encoder and the comparator for buffering encoded data outputted from the internal encoder together with the corresponding comparison result outputted from the comparator; and
a recorder coupled to the FIFO memory for performing pseudo-recording according to the comparison result;
wherein the laser control circuit is coupled to the recorder, and the laser control circuit controls the optical pickup whether to physically write on the optical disc according to the comparison result.

19. The optical disc drive of claim 15, wherein the data encoder further comprises:
an internal encoder coupled to the processor for performing internal encoding of the RUBs according to control of the processor;
a First In First Out (FIFO) memory coupled to the internal encoder for buffering encoded data outputted from the internal encoder;
a recorder coupled to the FIFO memory for performing pseudo-recording;
a counter positioned inside or outside the recorder for counting the second value; and
a comparator coupled to the counter and the processor for comparing the second value outputted from the counter and the target value outputted from the processor to output a comparison result;
wherein the laser control circuit is coupled to the recorder and the comparator, and the laser control circuit controls the optical pickup whether to physically write on the optical disc according to the comparison result outputted from the comparator.
